(19) United States
(12) Patent Application Publication
(10) Pub. No.: US 2018/0065312 A1
(43) Pub. Date: Mar. 8, 2018

(54) TWO-WAY STRETCHING AND PASTING DEVICE

(71) Applicant: PERMA PRODUCTS, Murarrie (AU)

(72) Inventor: Jamie Allan Yates, Murarrie (AU)

(21) Appl. No.: 15/585,595

(22) Filed: May 3, 2017

(30) Foreign Application Priority Data
Sep. 8, 2016 (CN) 201621044642.2

(51) Int. Cl. B29C 65/50

(52) U.S. Cl. CPC B29C 65/5092; B29C 65/5042

(57) ABSTRACT

A double pull tab stretch releasing adhesive tape having first and second pull tabs residing at first and second distal ends of an extensible tensile sheet. The first and second pull tabs have a plurality of anti-slip grip regions that enable a secure gripping hold by an end user. The double pull tab stretch releasing adhesive tape attaches two substrates together and is removed by simultaneously pulling the first and second pull tabs in opposing directions to generate a two-way stretching force along the longitudinal length. This force is exerted on and stretches the extensible tensile sheet to distort the first adhesive for removal of the double pull tab stretch releasing adhesive tape from the first substrate without the end user touching any substrates.

### BACKGROUND OF THE INVENTION

### 1. Field of the Invention

The present invention relates generally to pasting and connection fitting devices, and in particular, to methods and adhesive tapes that firmly attach substrates and are easily removed through a two-way stretch without damaging the substrate(s).

### 2. Description of Related Art

Double sided-stretch releasing adhesive tapes are commonly used to attach different substrates to one another. These stretch releasing tapes have adhesive materials on both sides thereof, and stretch once attached to the substrates for easy removal. In use, a first side of the double sided-stretch releasing adhesive tape adheres to a first substrate, while the second side adheres to a second substrate to assemble, join, attach or mount the substrates to each other. While double sided-stretch releasing adhesive tapes are known to attach a variety of different substrates to one another, a common use of these tapes is for removably securing a wall mount to a wallboard.

Once a stretch releasing adhesive tape secures different substrates to each other, the joined or attached substrates may then be separated from one another by stretching the stretch releasing adhesive tape. In order to stretch the tape, this stretch releasing adhesive tape also includes a single non-adhesive pull-tab at one end thereof. In use, after the stretch tape is applied between different substrates, the pull-tab extends out and beyond at least one of the substrates for easy pull and removal of the tape and at least one of the substrates.

For instance, referring to FIG. 1A, known stretch releasing adhesive tapes have a single pull tab 10 that resides and extends beyond a surface area of a wall mount 15 attached to a substrate (e.g. a wall) by such stretch releasing adhesive tape (not shown). In removing the wall mount 15 the end user must hold the wall mount 15 with one hand 20, while pulling on tab 10 with the other hand 22 as shown in FIG. 1B. This single pull-tab 10 is pulled in a downward direction at an angle to the surface to which the stretch releasing tape is bonded, thereby generating a downward force that is applied to the tape. The end user must pull the pull-tab 10 until the adhesive tape is stretched to a point at which it detaches from the substrate (e.g. a wall) that it is bonded to. As a result, the stretch releasing adhesive tape and wall mount are removed from the wall.

However, in the process of removing the double sided-stretch releasing adhesive tape, end users often pull and lift the pull-tab 10 at too much of an angle with respect to the surface to which the tape is attached, or exert too much force on the tab 10. As a result the pull-tab 10 breaks as shown in FIG. 1C, thereby making it difficult to remove the wall mount 15 and/or the stretch releasing adhesive tape without visibly damaging the wall or leaving tape residue behind on the wall. Another problem with known stretch releasing adhesive tapes is that the pull-tabs do not lend to easy gripping and handling thereof, such that, exerted pulling forces on such pull-tabs often results in breakage of the tabs, leading to further difficulty in removing the wall mount 15 and/or the stretch releasing adhesive tape.

### SUMMARY OF THE INVENTION

Bearing in mind the problems and deficiencies of the prior art, it is therefore an object of the present invention to provide methods and stretch releasing adhesive tapes that lend to easy gripping and handling thereof, as well as efficient and clean removal of such tape from a substrate surface.

It is another object of the present invention to provide methods and stretch releasing adhesive tapes that avoid breakage during use and removal thereof.

Still other objects and advantages of the invention will in part be obvious and will in part be apparent from the specification.

The above and other objects, which will be apparent to those skilled in the art, are achieved in the present invention which is directed to an elongated stretch releasing adhesive tape article removable from a substrate by stretching. The tape article includes an extensible tensile sheet having a first side and a second side, with a first adhesive on the first side and a second adhesive on the second side thereof. A first pull tab is connected to a first longitudinal end of the extensible tensile sheet, while a second pull tab is connected to a second opposing longitudinal end thereof. A plurality of anti-slip grip regions reside on both the first pull tab and the second pull tab. The plurality of anti-slip grip regions enable a secure gripping hold by an end user of both the first and second pull tabs, during simultaneous pulling thereof, to generate a two-way stretching force in a lengthwise direction. This force is exerted on and stretches the extensible tensile sheet as well as distorts at least one of the first or second adhesives for removal of the elongated stretch releasing adhesive tape from a substrate.

In another embodiment, the invention is also directed to methods of removably bonding a stretch releasing adhesive tape from a substrate. A double pull tab stretch releasing adhesive tape is provided that includes an extensible tensile sheet having a first adhesive on a first side and a second adhesive on a second side, the extensible tensile sheet having a longitudinal length with first and second distal ends, and a first pull tab connected to the first longitudinal end and a second pull tab connected to the second longitudinal end. Both first and second pull tabs have a plurality of anti-slip grip regions. A first substrate is attached to a second substrate using the double pull tab stretch releasing adhesive tape by bonding the first adhesive to the first substrate and bonding the second adhesive to the second substrate. The first substrate is then detached from the second substrate by an end user gripping both the first pull tab and the second pull tab followed by simultaneously pulling the first and second pull tabs in opposing directions to generate a two-way stretching force along the longitudinal length. This force is exerted on and stretches the extensible tensile sheet to distort at least the first adhesive for removal of the double pull tab stretch releasing adhesive tape from at least the first substrate without the end user touching the first or second substrates.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1A-1C are perspective views single tab double sided-stretch releasing adhesive tape of the Prior Art.

FIGS. 2A-2B are perspective views of a double pull tab stretch releasing adhesive tape in accordance with one or more embodiments of the invention.

FIG. 3 is a perspective view of the double pull tab stretch releasing adhesive tape of FIGS. 2A-2B attached to a first substrate.

FIG. 4 is a side view of the double pull tab stretch releasing adhesive tape of FIG. 3 attached between two substrates.

FIGS. 5A-5B are perspective views showing removal of the double pull tab stretch releasing adhesive tapes of FIG. 4 in accordance with the invention.

FIGS. 6A-6B are perspective views of one or more embodiments showing use of a plurality of double pull tab stretch releasing adhesive tapes of the invention.

### DESCRIPTION OF THE PREFERRED EMBODIMENT(S)

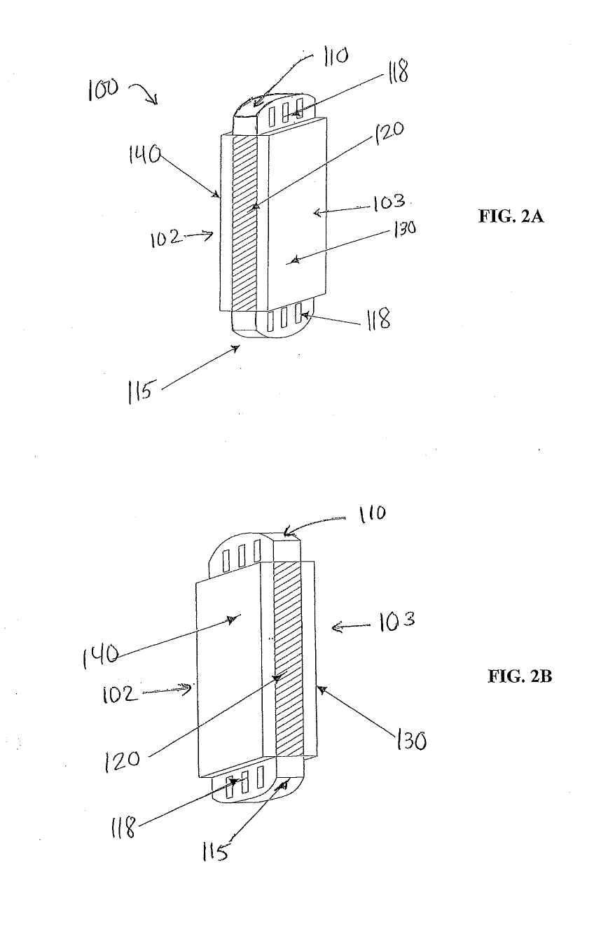

In describing the preferred embodiment of the present invention, reference will be made herein to FIGS. 2A-6B of the drawings in which like numerals refer to like features of the invention.

Referring to the drawings, FIGS. 2A-2B show perspective views of a double pull tab, double sided-stretch releasing adhesive tape 100 according to the present invention. The double pull tab stretch releasing adhesive tape 100 of the invention includes a tensile sheet 120 having a first pull tab (label) 110 at a first end thereof and a second pull tab 115 at an opposite second end thereof. Both of the pull tabs 100, 115 have one or more anti-slip grips 118 for helping an end user to attain and retain a firm grip on such pull tabs 100, 115 during removal of the double pull tab stretch releasing adhesive tape 100. Attached to a first lateral side 102 of the tensile sheet 120 is a first adhesive 140, and attached to a second lateral side 103 of the tensile sheet 120 is a second adhesive 130.

In accordance with one or more embodiments of the invention, the tensile sheet 120 may comprise one or more layers of any known highly extensible sheet material. The extensible material of the elastic tensile sheet 120 is capable of extending or stretching in a direction relative to forces being exerted on the sheet during simultaneous pulling of the double pull tabs 110, 115. As such, the extensible tensile sheet 120 material preferably has a high tensile strength, a lengthwise elongation capability of stretching up to 4-times the original length of such sheet 120, and substantial inelasticity recovery after being stretched (e.g., less than about 50% elastic recovery after being stretched).

While not meant to limit the invention, in one or more embodiments exemplary materials of the extendable tensile sheet 120 may include, but are not limited to, a synthetic rubber (e.g., SIS (styrene isoprene styrene) which is a thermoplastic elastomer including phenyl ethylene, methyl and butadiene), ethylene vinyl acetate (EVA) foam, clear ethylene vinyl acetate (EVA), polymeric films, polyolefins (e.g. polyethylene, polypropylene, and polybutylenes), vinyl copolymers (e.g. polyvinyl chlorides and polyvinyl acetates), olefinic copolymers, acrylic polymers and copolymers, as well as mixtures, blends (e.g., polypropylene/polyethylene, polyurethane/polyolefin, polyurethane/polycarbonate, polyurethane/polyester), and combinations of any of the foregoing. Other suitable elastomeric tensile sheet 120 materials include, for example, styrene-butadiene copolymer, polychloroprene (i.e., neoprene), nitrile rubber, butyl rubber, polysulfide rubber, cis-1,4-polyisoprene, ethylene-propylene terpolymers (e.g., EPDM rubber), silicone rubber, silicone polyurea block copolymers, polyurethane rubber, polyisobutylene, natural rubber, acrylate rubber, thermoplastic rubbers, e.g., styrene-butadiene block copolymers and styrene-isoprene-styrene block copolymers, and thermoplastic polyolefin rubber materials.

It should be appreciated that the tensile sheet 120 may be composed of a single layer having its characteristic properties residing throughout the length and thickness thereof. Alternatively, the tensile sheet 120 may be composed of a number of different layers, each having the same or different physical characteristics. Attached to opposing lateral sides 102, 103 of the tensile sheet 120 are the first and second adhesives 140, 130. Prior to use of the present double pull tab stretch releasing adhesive tape 100, each of the first adhesive 140 layer and second adhesive 130 layer may optionally be covered by a liner layer (not shown) to protect the exterior surface of such adhesives 140, 130. Any known liner layer may be used that is suitable to protect the adhesiveness of such layer 140, 130 prior to use thereof. For instance, the liner layers may be a coating such as film, paper, powder, foam, ink, release liner, or other material on the adhesive 140, 130 surfaces to render such surfaces non-adhesive for the protection thereof. The double pull tab stretch releasing adhesive tapes 100 of the invention preferably have a thickness sufficient to enable handling, use and removal (stretching) thereof. In one or more embodiments, the double pull tab stretch releasing adhesive tapes 100, including the tensile sheet 120 adhesive 140, 130 layers, have a thickness ranging from about 5 mils to about 10 mils.

In accordance with the various embodiments of the invention, each adhesive 140, 130 layer is composed of a stretch releasing pressure sensitive adhesive material. This material preferably is capable of forming bonds with a variety of different substrates, maintains adhesion to such substrates under various environmental conditions (e.g., high humidity, low humidity, high temperatures, low temperatures, etc.), is highly extensible (i.e., extendable and/or stretchable), and is easily removable from the substrate(s) after bonded thereto without damaging the substrate. The pressure sensitive adhesive material is preferably cleanly removable (i.e., does not leave a visible residue) from a variety of substrate surfaces including, for example, glass, ceramic, painted wallboard, finished wood (e.g., stained and varnished), tile, brick, etc.

While not meant to limit the invention, in one or more embodiments exemplary materials of the adhesive 140, 130 layers may include, but are not limited to, a synthetic rubber glue, silicone-based pressure sensitive adhesive compositions (e.g., resins and silicone polymer blends), tackified rubber adhesives (e.g., natural rubber, olefins, silicones, polyisoprene, polybutadiene, polyurethanes, styrene-isoprene-styrene and styrene-butadiene-styrene block copolymers, elastomers), tackified or untackified acrylic adhesives (e.g., copolymers of isooctylacrylate and acrylic acid), as well as mixtures (e.g., additives added thereto, such as pigments, fillers, etc.), blends, and combinations of any of the foregoing. In one or more embodiments the adhesives 140, 130 may be a synthetic rubber glue (i.e., SIS (styrene isoprene styrene)) glue having resins including E-5400, SR-100P and Tamanol 803, with remaining constituents of solvents and chemical additives.

Referring again to FIGS. 2A-2B, the double pull tab stretch releasing adhesive tapes 100 of the invention also includes a pair of pull tabs 110, 115 (i.e., double pull tabs 110, 115) on opposing ends of the tensile sheet 120. Each pull tab 110, 115 is composed of a non-adhesive material having a number of anti-slip grip 118 regions that prevent a user from losing hold of such pull tab during removal of the double pull tab tape 100 from a substrate surface. The first pull tab 110 resides at a top surface of the tensile sheet 120, and extends beyond both the tensile sheet 120 and the adhesive 140, 130 layers. The second pull tab 115 resides at a bottom surface of the tensile sheet 120 (at an opposite end of the first pull tab 100) and also extends beyond the tensile sheet 120 and the adhesive 140, 130 layers.

In fabricating the extensible tensile sheet 120 and pull tabs 110, 115, such components may be fabricated together at the same, or the pull tabs 110, 115 may be permanently affixed to the tensile sheet 120 after fabrication thereof. As such, the pull tabs 110, 115 may also be composed of a non-adhesive extensible material that is capable of extending or stretching in a direction relative to forces being exerted during simultaneous pulling of such double pull tabs 110, 115. In these embodiments, the extensible pull tab material may have a high tensile strength, a lengthwise elongation capability of stretching, and substantial inelasticity recovery after being stretched. Further in these embodiments the tensile sheet 120 and the pull tabs 110, 115 may be fabricated together and comprise a same material, or the pull tabs may be later attached to the tensile sheet 120 whereby the pull tabs and tensile sheet comprise a same or different materials. In alternate embodiments, the non-adhesive pull tabs 110, 115 may be composed of a substantially non-stretchable material and are attached to the extensible tensile sheet 120 at opposite ends thereof after fabrication.

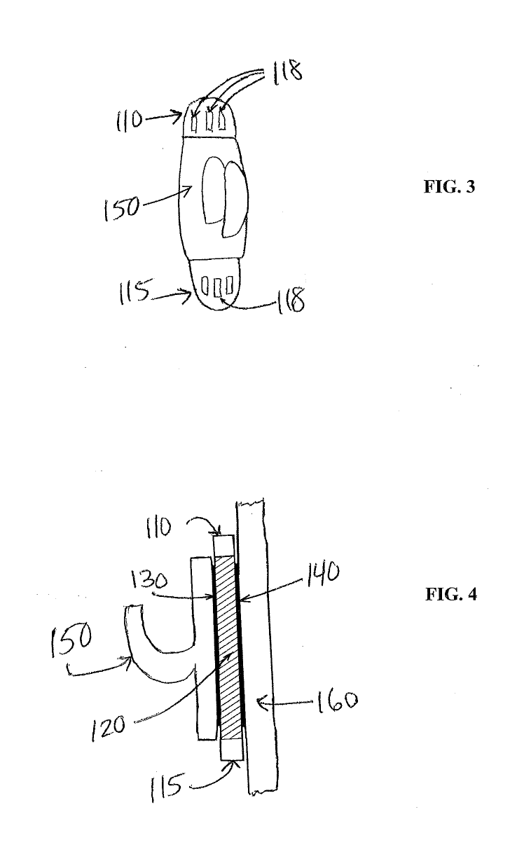

Referring to FIG. 3, in accordance with the various embodiments of the invention, the pull tabs 110, 115 have a number of anti-slip grip 118 regions that facilitate the holding and pulling of such tabs 110, 115. These anti-slip grips 118 also assist in the removal of the present double pull tab stretch releasing adhesive tape 100 from a substrate surface. These anti-slip grips 118 may include any type of gripping structure that facilitates in providing a non-slipping hold or grip of such tabs 110, 115. While not meant to limit the invention, the anti-slip grips 118 may include, but are not limited to, a plurality of grooves that run along front and back sides of the pull tabs, a plurality of openings that traverse through a thickness of the pull tabs (i.e., open at front and back), a plurality of raised gripping protrusions extending from surfaces of the tabs, and the like.

As shown in FIG. 4, in use the double pull tab stretch releasing adhesive tape 100 of the invention may be used to join, attach, bond, secure or bring together two or more substrates in a strong hold that is releasable via the tape 100. The first adhesive 140 at the first lateral side 102 is securely attached to a first substrate 160, while the second adhesive 130 at the second lateral side 103 is securely attached to a second substrate 150. The extensible tensile sheet 120 resides between these first and second substrates 160, 150, as well as between the first and second adhesives 140, 130. Optionally, in those embodiments having liner layers protecting the adhesive layers, such liners are removed prior to applying the first and second adhesive 140, 130 layers to the substrates to be joined.

While not meant to limit the invention, the double pull tab stretch releasing adhesive tape 100 is suitable for a variety of applications including, but not limited to, bonding two substrates together, mounting applications using articles including (e.g., hooks, hangers, holders, wall hangings, decorations, pictures, calendars); joining applications such as adhering two or more containers; labeling applications; fastening applications; securing applications, and combinations of any of the foregoing. These applications may also including mounting, joining, securing, etc. two or more substrates together in wet or high humidity environments (e.g., bathrooms), or even articles in low temperatures (e.g. outdoor applications, windows, vehicles, or refrigerators).

In accordance with the invention, the pair of pull tabs 110, 115 are both exposed beyond a surface area of at least one of the substrates so that an end user can grip such pull tabs 110, 115 for removal of the tape 100. For ease of understanding the invention, FIG. 4 shows the first substrate 160 comprising a wallboard (i.e., 160) and the second substrate 150 comprising a mounting hook (i.e., 150). As is shown the first pull tab 110 extends above and is exposed beyond a surface area of the mounting hook (150), while the second pull tab 115 extends below and is exposed beyond the surface area of such mounting hook.

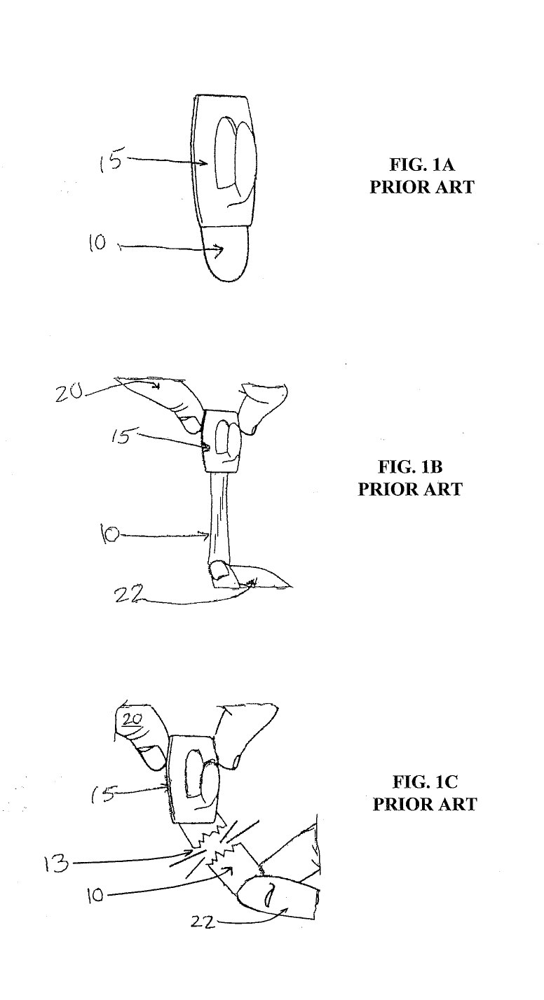

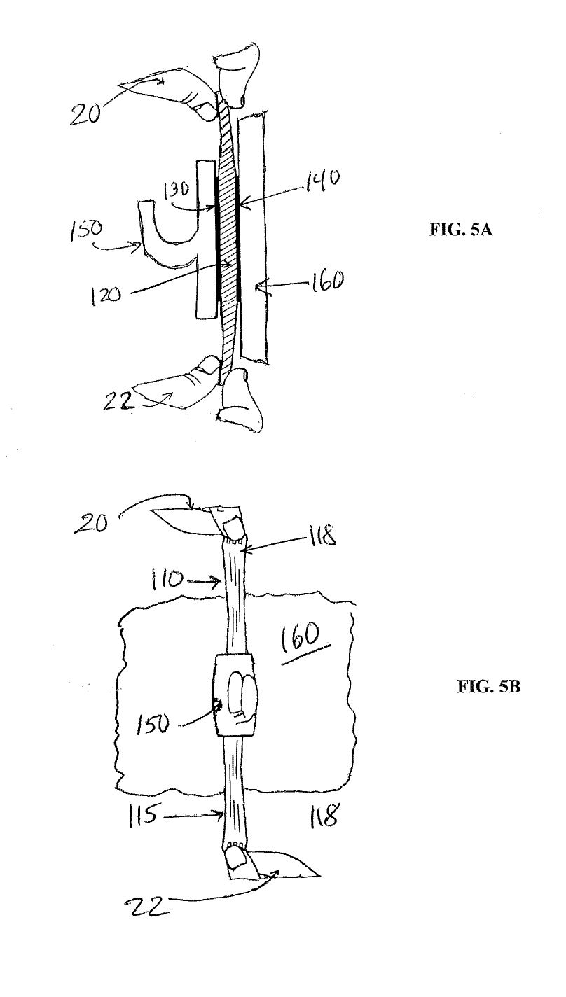

Referring to FIGS. 5A-5B, debonding of one or both adhesives 130, 140 from one or both substrates 150, 160, respectively, is achieved by an end user simultaneously pulling both pull tabs 110, 115 to stretch the double pull tab stretch releasing adhesive tape 100. A user's fingers of a first hand 20 grabs hold of the first pull tab 110, while fingers of the user's second hand 22 grab hold of the second pull tab 115. The anti-slip grip 118 regions on each pull tab 110, 115 allow the end user to attain a stead fast grip on the pull tabs, thereby preventing slippage of such pull tabs from the user's fingers (i.e., the user loses grip of the tabs). It should be appreciated that slippage of the pull tab from the user's fingers is undesired during the tape removal process since it may have a detrimental effect on the removal process and/or the adhesive tape itself. For instance, referring to the prior art drawing of FIG. 1C, slippage may exert undesired interruptions and/or forces on the tab and tape that result in breakage of such pull tab, thereby making it difficult, if not impossible, to remove the tape from the wall without damage thereto.

During the tape 100 removal process, the pull tabs 110, 115 of the invention are simultaneously and compressively gripped by the end user, and then pulled in opposing directions from one another, as well as away from opposite ends of the substrate being removed (e.g., mount 150). In doing so, the pull tabs 110, 115 reside on opposite sides of the substrate being removed and may be pulled in opposing longitudinal or lateral directions depending on the orientation that the tape 100 has been affixed to the substrate.

In accordance with the invention, the end user pulls the double pull tabs 110, 115 simultaneously in a two-way opposing lengthwise direction to exert a two-way stretching force upon the tape 100, as shown in FIG. 5B. This two-way stretching force is facilitated by the pair of pull tabs with anti-slip grips 118 and provide a more even and continuous stretch along the length of the extensible tensile sheet 120. The generated two-way stretching force extends across the tape 100 in a direction substantially parallel to the surface of the substrate. The anti-slip grips 118 enable the end user to maintain a constant hold of the pull tabs 110, 115 to exert this continuous two-way stretching force (pressure) across the entirety of tape 100 (i.e., including length, wide and thickness of tape 100). While the double pull tabs 110, 115 are pulled substantially parallel to the direction of at least one of the substrates (e.g., wall 160), such pull tabs 110, 115 may also be pulled at a slight angle with respect to the substrate. For instance, the pull tabs 110, 115 may be pulled in a direction up to an angle of about 30 degrees from the substrate surface to facilitate removal of the tape 100.

In the removal process, as the pair of pull tabs 110, 115 are pulled, the two-way stretching force is applied to the extensible tensile sheet 120. As the extensible tensile sheet 120 is stretched and elongated, one or both of the adhesive 140, 130 layers attached thereto are also distorted in lateral, longitudinal, or both directions across the adhesive surfaces. That is the two-way stretching forces of the invention are also applied to the adhesive 140, 130 layers. As these adhesive 140, 130 layers are distorted, the bond between such adhesive 140, 130 layers and the substrate(s) begins to break, and completely breaks upon continued and increased two-way stretching forces that are generated as the pull tabs 110, 115 are pulled farther away from one another. In one or more embodiments the extensible tensile sheet 120 may be capable of stretching up to about 4-times its original length through the continuous opposing direction pulling of pull tabs 110, 115.

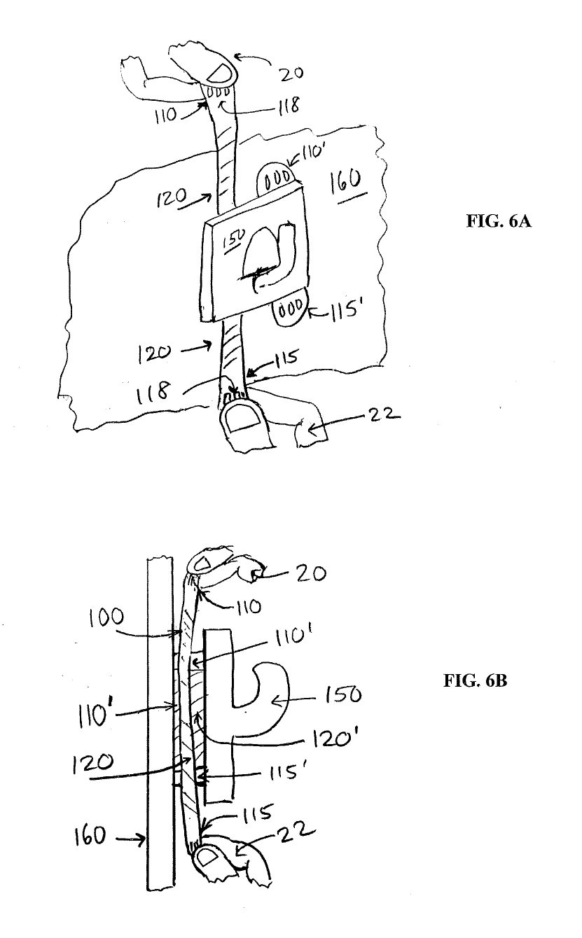

In one or more embodiments a plurality of double pull tab stretch releasing adhesive tapes 100 of the invention may be used in combination with each other to join one substrate to another substrate. For instance, referring to FIGS. 6A-6B a first double pull tab stretch releasing adhesive tape 100 is used in combination with a second double pull tab stretch releasing adhesive tape 100′ to attach a single substrate to another substrate. As shown, mounting hook 150 is adhered to the wallboard 160 using at least two different pull tab stretch releasing adhesive tapes 100 of the invention. In use, the plurality of present tapes 100, 100′ are attached to the mounting hook 150 at the first adhesive layer and then the mounting hook 150 is secured to the wall 160 via the second adhesive layer.

In removing the ‘plurality of tapes 100, 100’ of the invention, a first double pull tab tape 100 is removed by simultaneously pulling its respective pair of pull tabs 110, 115 in opposing directions. As shown in FIG. 6B the first double pull tab tape 100 is stretched to an extent that the entirety of such first double pull tab tape 100 is detached from both substrates 150, 160, particularly the tensile sheet 120, and may then be slid out from between the substrates. The remaining second double pull tab tape 100′ remains intact and is held between the two substrates 150, 160 (see, FIG. 6B). After removal of the first double pull tab tape 100 the second double pull tab tape 100′ may then be removed through stretching of its tensile sheet 120′ by simultaneously pulling pull tabs 110′ and 115′.

It should further be appreciated that in addition to using two or more double pull tab tapes 100, 100′ in a side-by-side orientation, the double pull tab tapes of the invention may also be used as two or more double pull tab tapes residing one over the other. That is, each double pull tab tape may have two (or more) individual double pull tab tapes 100 layered one over the other. In such an instance, each end of the tensile sheet may have two (or more) separate pull tabs that are layered one over the other. In these embodiments, the double pull tab tapes 100 of the invention may have one of the adhesive layers removed and replaced by a removably attachable and detachable fastening component that allows one of the substrates having a first of the layered double pull tab tapes to be removed from the second double pull tab tape, and then at a later time reaffixed or reattached to such second double pull tab tape. In these embodiments, the double pull tab tapes of the invention may each have a first side having the adhesive thereon and a second side having a fastening device that allows attachment, removal, and reattachment of a first substrate to a second substrate. While not meant to limit the invention, the fastening devices may include, for example, hook and loop fasteners (i.e., Velcro™), snaps, clips, hooks, and the like.

As an exemplary embodiment, a first double pull tab tape may be attached to a wall mount via the adhesive layer, whereby on the opposite side of the tensile sheet of the first tape resides a first component part of the removably attachable and detachable fastening device. A second double pull tab tape may be attached to a wall via another adhesive layer, whereby on the opposite side of the tensile sheet of the second tape resides a second mating component part of the removably attachable and detachable fastening device. An end user may attach the wall mount to the wall using the mating fastening devices, and at a later time, may detach the wall mount from the wall by breaking the mating connection between the mating fastening device, or alternatively remove the double layers of tapes by simultaneously pulling the pull tabs of the second tape attached to the wall to remove both tapes as well as the wall mount. In those embodiments where the second tape is left remaining attached to the wall (i.e., only the wall mount has been removed), the removed wall mount may be later reattached to the second tape, or alternatively, a different substrate (e.g., a different type of wall mount) may be attached to the remaining second tape. It should be appreciated that many variants of the instant embodiments are envisioned and encompassed within the invention.

It has been found that the double pull tab stretch releasing adhesive tapes 100 of the invention rapidly, conveniently, cleanly, and safely are removed from the substrate without causing damage to such substrate(s). It has also been found that the various tapes 100 of the invention are cleanly removable from the substrate(s) and leave no visible residue remaining on the substrate. The double pull tabs 110, 115 on opposing lengthwise ends of the tapes 100 of the invention allow for an end user to remove a substrate held to another substrate via the present double pull tab tapes 100 without hold the substrate being removed. For instance, in conventional stretch releasing tapes pull tabs are provided only at one end of such conventional tapes, such that upon removal of the substrate, an end user must hold the substrate (e.g., mounting hook) with one hand while pulling down on the pull tab with the other hand (see, e.g., FIGS. 1B and 1C). This often leads to undesired pressures applied to the substrate that may interfere with the stretching removal properties of the conventional tape, thereby causing breakage of the conventional tape (see, e.g., FIG. 1C), incomplete removal of the tape from the wall, and/or damage to such wall. The present invention avoids these defects of the prior art since an end user of the present double pull tab stretch releasing adhesive tapes 100 does not need to hold the substrate that is being removed—only the pair of pull tabs 110, 115 are held and pulled for complete stretch removal of the instant tapes 100.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An elongated stretch releasing adhesive tape article removable from a substrate by stretching comprising:
an extensible tensile sheet having a first side and a second side;
a first adhesive on said first side of the extensible tensile sheet;
a second adhesive on said second side of the extensible tensile sheet;
a first pull tab connected to a first longitudinal end of the extensible tensile sheet;
a second pull tab connected to a second opposing longitudinal end of the extensible tensile sheet;
a plurality of anti-slip grip regions on both the first pull tab and the second pull tab, whereby the plurality of anti-slip grip regions enable a secure gripping hold by an end user of both the first and second pull tabs during simultaneous pulling thereof to generate a two-way stretching force in a lengthwise direction that is exerted on and stretches said extensible tensile sheet and distorts at least one of the first or second adhesives for removal of the elongated stretch releasing adhesive tape from a substrate.

2. The article of claim 1 wherein the extensible tensile sheet comprises a non-adhesive material.

3. The article of claim 1 wherein the first and second pull tabs comprise a non-adhesive material.

4. The article of claim 1 wherein the plurality of anti-slip grip regions separate the first pull tab and the second pull tab from the extensible tensile sheet.

5. The article of claim 4 wherein the anti-slip grip regions are selected from the group consisting of grooves, openings, indentations, raised protrusions, ridges, and combinations thereof.

6. The article of claim 1 wherein the extensible tensile sheet and the first and second pull tabs comprise a single non-adhesive elongated sheet material formed as a one-piece structure.

7. The article of claim 1 wherein the extensible tensile sheet comprises a first material, the first and second pull tabs comprise a second material, and the first and second pull tabs are connected to the extensible tensile sheet at opposite longitudinal ends thereof.

8. The article of claim 7 wherein the first and second materials comprise a same material.

9. The article of claim 7 wherein the first and second materials comprise different materials.

10. A method of removably bonding a stretch releasing adhesive tape from a substrate comprising:
providing a double pull tab stretch releasing adhesive tape comprising,
an extensible tensile sheet having a first adhesive on a first side and a second adhesive on a second side, the extensible tensile sheet having a longitudinal length with first and second distal ends, a first pull tab connected to the first longitudinal end and a second pull tab connected to the second longitudinal end, and a plurality of anti-slip grip regions on both the first and second pull tabs;
attaching a first substrate to a second substrate using the double pull tab stretch releasing adhesive tape by bonding the first adhesive to the first substrate and bonding the second adhesive to the second substrate;
detaching the first substrate from the second substrate by an end user gripping both the first pull tab and the second pull tab followed by simultaneously pulling said first and second pull tabs in opposing directions to generate a two-way stretching force along the longitudinal length that is exerted on and stretches said extensible tensile sheet to distort at least the first adhesive for removal of the double pull tab stretch releasing adhesive tape from at least the first substrate without the end user touching said first or second substrates.

11. The method of claim 10 wherein the plurality of anti-slip grip regions enable a secure gripping hold by an end user to generate the two-way stretching force.

12. The method of claim 10 wherein the plurality of anti-slip grip regions separate the first pull tab and the second pull tab from the extensible tensile sheet.

13. The method of claim 10 wherein the anti-slip grip regions are selected from the group consisting of grooves, openings, indentations, raised protrusions, ridges, and combinations thereof.

14. The method of claim 10 wherein the anti-slip grip regions are selected from the group consisting of grooves, openings, indentations, raised protrusions, ridges, and combinations thereof.

15. The method of claim 10 wherein the two-way stretching force is generated simultaneously at both the first and second distal ends of the longitudinal length in opposing directions.

16. The method of claim 10 wherein the extensible tensile sheet and the first and second pull tabs comprise a single non-adhesive elongated sheet material formed as a one-piece structure.

17. The method of claim 10 wherein the extensible tensile sheet comprises a first material, the first and second pull tabs comprise a second material, and the first and second pull tabs are connected to the extensible tensile sheet at opposite longitudinal ends thereof.

18. The method of claim 10 wherein the extensible tensile sheet is capable of stretching up to 4-times an original length of said extensible tensile sheet.

19. The method of claim 10 further including a plurality of said double pull tab stretch releasing adhesive tapes attaching the first substrate to the second substrate, the method further including:
detaching a first of the plurality of said double pull tab stretch releasing adhesive tapes by simultaneously pulling first and second pull tabs thereof until said first double pull tab stretch releasing adhesive tape releases from both said first substrate and said second substrate;
removing said first double pull tab stretch releasing adhesive tape from between said first substrate and said second substrate, whereby one or more others of said plurality of said double pull tab stretch releasing adhesive tapes continues to reside between the first and second substrates; and
sequentially removing the one or more others of said plurality of said double pull tab stretch releasing adhesive tapes from between said first and second substrates to detach the first substrate from the second substrate.

20. The method of claim 10 further including a plurality of said double pull tab stretch releasing adhesive tapes attaching the first substrate to the second substrate, whereby at least a first double pull tab stretch releasing adhesive tape resides over a second double pull tab stretch releasing adhesive tape to provide layered first and second double pull tab stretch releasing adhesive tapes, the layered first and second double pull tab stretch releasing adhesive tapes being secured to one another by a removably attachable and detachable fastening device.
